(19) United States
(12) Patent Application Publication
(10) Pub. No.: US 2010/0139469 A1
(43) Pub. Date: Jun. 10, 2010

(54) CUTTING TOOL

(76) Inventor: Paul Matteucci, Genova (IT)

Correspondence Address: STITES & HARBISON PLLC, 1199 NORTH FAIRFAX STREET, SUITE 900, ALEXANDRIA, VA, 22314, US

(21) Appl. No.: 12/530,494

(22) PCT Filed: Mar. 7, 2008
(86) PCT No.: PCT/EP08/52794

§ 371 Date: Jan. 28, 2010

(30) Foreign Application Priority Data
Mar. 14, 2007 (IT) GE2007A000032

(51) Int. Cl. B26D 1/24

(52) U.S. Cl. 83/495

(57) ABSTRACT

Cutting tool comprising a structural member (1, 1′) provided with means (301, 401) for engagement with operating means, and a plurality of cutting edges (201, 201′) connected to said structural member (1, 1′), intended to follow a given cutting path; said cutting edges (201, 201′) are each connected to said structural member (1, 1′) by means of a suitable support part (101, 101′) connected at one end to said structural member (1, 1′), oriented in a manner substantially perpendicular to the plane of said cutting path and having said cutting edge (201, 201′) at its free end, the cutting edges (201, 201′) connected to two adjacent support parts being arranged in substantial opposition to each other with respect to said cutting path.

The present invention relates to tools and in particular relates to a cutting tool.

Conventional blade-type tools which are customarily used to cut standard materials must satisfy the following requirements: be designed with cutting edges (teeth or inserts) made of materials harder than the material to be cut; move at a suitable speed so as to be able to create friction on the material being cut and remove from it a thin film or “shaving”; have shaped teeth so as to create a clearance, or “pathway”, which is greater than the thickness of the structural support part of the tool which advances behind the cutting edge.

In order to use these systems, whether they be band-type sawing blades, disk-type blades or milling cutters, it is required that the cutting edge be firmly fixed and that the portions produced by the cut are not subject to movements since in some cases even a small movement could cause breakage of the cutting edges and/or jamming and consequent stoppage of the tool.

The object of the present invention is to provide a tool which is able to limit as far as possible the consequences of the abovementioned drawbacks, preventing the possibility of seizing during the cutting operation should the cut portions move towards each other.

The present invention therefore relates to a cutting tool comprising a structural member provided with means for engagement with operating means, and a plurality of cutting edges connected to said structural member, intended to follow a given cutting path, characterized in that said cutting edges are each connected to said structural member by means of a suitable support part connected at one end to said structural member, oriented in a manner substantially perpendicular to the plane of said cutting path and having said cutting edge at its free end, the cutting edges connected to two adjacent support parts being arranged in substantial opposition to each other with respect to said cutting path.

In a preferred embodiment, said support parts are made of resilient material;

preferably these support parts comprise strips of metallic material which extend from the structural member and in particular are formed as one piece therewith.

Said structural member may assume the most varied forms, namely it may comprise a band-like member, a cup-shaped member or a disk-shaped member. The cutting edges may be formed as one piece on said support parts, and likewise may instead consist of inserts which are suitably fixed to said support parts.

Further advantages and characteristic features will emerge clearly from the following description of an embodiment of the present invention provided, by way of a non-limiting example, with reference to the accompanying drawings in which:

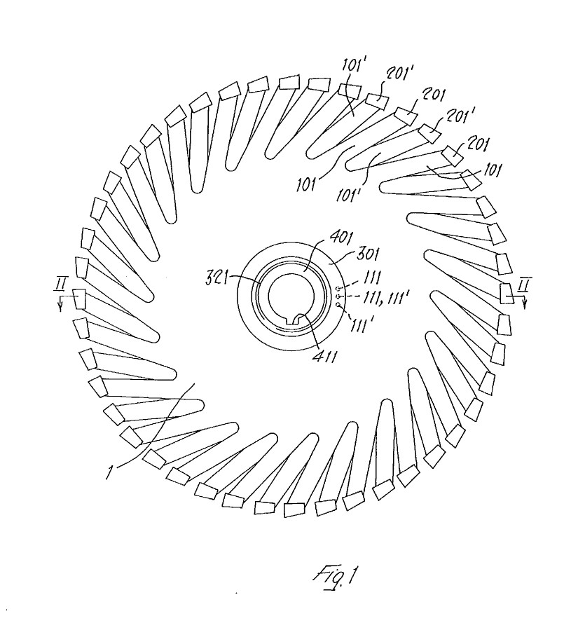

FIG. 1 is a plan view of an embodiment of the cutting tool according to the present invention; and

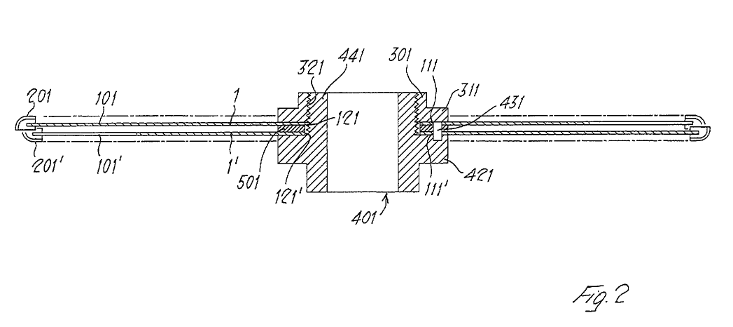

FIG. 2 is a cross-sectional view along the line II-II of FIG. 1.

FIG. 1 shows a cutting tool according to the present invention; 1 denotes the structural member of said tool, which comprises two disks 1 and 1′ (see FIG. 2) from which a plurality of arms 101, 101′ supporting the cutting edges 201, 201′ extend; the two disks 1, 1′ are, in this case, joined together by means of the ring 301 which is screwed onto the bush 401. The bush 401 also has the internal radial cavity 411 which allows engagement thereof with the power take-off of the operating means (not shown in the figure). The holes 111, 111′ formed in the disks 1 and 1′ respectively are shown in broken lines and allow relative positioning of the two disks, as can be seen from the illustration of FIG. 2.

FIG. 2 shows the tool according to FIG. 1 cross-sectioned along the line II-II. As can be noted, the disk 1′ is positioned with its axial hole 121′ on the threaded sleeve 441 of the bush 401, as is the axial hole 121 of the disk 1; the spacing ring 501 is gripped between the two disks and the disks are positioned relative to each other owing to the different positioning of the holes 111 and 111′ which engage with the pin 431 projecting axially from the flange 421 of the bush 401. The threaded cavity 321 of the ring 301 engages with the threaded sleeve 441 of the bush 401, and the flange 311 of the ring presses against the surface of the disk 1, thus locking the tool. The arms 101 and 101′ are thus alternately arranged with respect to each other, and the cutting edges 201, 201′ of each of the two disks 1, 1′ are situated substantially opposite the line of the cutting path; in particular, two adjacent cutting edges 201, 201′ overlap by a small amount, along the height of each cutting edge.

In addition to the function mentioned above, the pin 431 also has the function of keeping the disks 1, 1′ also in a stressed position during rotation, keeping them rigidly fixed to the flange 421 of the bush 401 which is keyed by means of the radial cavity 411 to the power take-off of the operating means (not shown).

The operating principle of the cutting tool according to the invention will become clear from the description below. The cutting edges 201, 201′ are, in the embodiment shown, each arranged at the free end of an arm 101, 101′ which projects radially from the respective disk 1, 1′ and which is made, like the remainder of the disk with which it is formed as one piece, of metallic material or resilient material. This elastic deformation capacity of the cutting edge supports provides the cutting tool according to the invention with a notable ability to adapt: in fact the cutting edge, consisting of a “virtual” cutting edge which has a height substantially equal to the sum of the heights of two adjacent cutting edges, less their overlapping portion, as can be seen in

FIG. 2, is able to adapt also to substantial reductions in the distance between the parts of the object being cut.

Basically, with a decrease in the height of the cutting pathway, the supports 101, 101′ of the cutting edges flex, thus preventing the tool from jamming inside the said cutting pathway. Moreover, the speed of displacement would allow the cut to resume its initial width owing to the spring effect exerted by the supports on the cutting edges.

In the preferred embodiment shown and described here, the tool consists of two circular blades arranged on top of each other; it is clear that the same type of result could be achieved with a single circular blade, although this type of solution on the one hand makes the machining operations simpler, since the number of supports on each blade is half the number of those envisaged on the whole tool; moreover, the solution adopted envisages joining together two disks which are in fact identical to each other and which are suitably connected owing to the presence, on each disk, of two holes 111 and 111′, respectively, which are angularly spaced by a suitable amount. The disks are positioned on the bush 401 in the manner shown in FIG. 1. A further advantage of the tool constructed in this way clearly emerges from the fact, with regard to the stresses produced by a reduction in the height of the so-called cutting pathway, positioning thereof in the manner shown in FIG. 1 results in their having a more effective elastic response; in fact, each support part is situated with its end connected to the body of the respective disk substantially in contact with the corresponding ends of another two support parts of the other disk.

The support parts 101, 101′ are provided angularly spaced from each other and with a given inclination with respect to the radius of the disk. Their length is chosen so as to provide a compromise between structural integrity of the tool and capacity for elastic return movement of the support part.

It must be emphasized that the tool according to the present invention has been shown by way of example in the form of a disk, but it could also be formed as a band-like cutting tool or a cup-shaped tool, without thereby departing from the protective scope defined by the claims attached below.

The cutting edges may be formed as one piece with the support parts or may be stably connected to them using any means or also may consist of a suitable abrasive material mounted on a base formed as one piece with the support part or fastened thereto.

As already mentioned above, the cutting edges are arranged on the support parts so that two adjacent cutting edges are arranged on opposite sides with respect to the cutting path of the tool; this allows the formation of a cutting pathway which is overall wider and allows the characteristic effects of the present invention to be exploited to the full.

A cutting tool so conceived may be used in the most difficult cutting conditions and is able to reduce to a minimum the risk of seizing, with consequent stressing of the apparatus used and damaging thereof and/or the tool itself, associated with the reduction in the distance between the portions of the object being cut.

1. Cutting tool comprising a structural member (1, 1′) provided with means (301, 401) for engagement with operating means, and a plurality of cutting edges (201, 201′) connected to said structural member (1, 1′), intended to follow a given cutting path, characterized in that said cutting edges (201, 201′) are each connected to said structural member (1, 1′) by means of a suitable support part (101, 101′) connected at one end to said structural member (1, 1′), oriented in a manner substantially perpendicular to the plane of said cutting path and having said cutting edge (201, 201′) at its free end, the cutting edges (201, 201′) connected to two adjacent support parts being arranged in substantial opposition to each other with respect to said cutting path.

2. Tool according to claim 1, in which said support parts (101, 101′) are made of resilient material.

3. Tool according to claim 2, in which said support parts (101, 101′) are made of metallic material.

4. Tool according to claim 2, in which said support parts (101, 101′) are made as one piece with said structural member (1, 1′).

5. Tool according to claim 1, in which said cutting edges (201, 201′) are formed as one piece on said support parts.

6. Tool according to claim 1, in which said cutting edges (201, 201′) are inserts suitably fixed to said support parts.

7. Tool according to claim 1, in which said structural member comprises a band-like member.

8. Tool according claim 1, in which said structural member comprises a cup-shaped member.

9. Tool according to claim 1, in which said structural member comprises a disk-shaped member.

10. Tool according to claim 9, in which said structural member comprises at least one disk (1,1′) from which there extend a plurality of arms (101, 101′) which are formed as one piece therewith and at the free ends of which the respective cutting edges (201, 201′) are arranged.

11. Tool according to claim 10, in which said arms (101, 101′) are inclined at a given angle with respect to the radius of the said disk (1, 1′).

12. Tool according to claim 10, in which said tool comprises two disks (1, 1′) which are joined together via said means (301, 401) for engagement with said operating means, the two disks being suitably staggered with respect to each other, so that the arms (101) of one disk (1) are arranged in between the arms (101′) of the other disk (1′), the respective cutting edges situated on each of the disks (1, 1′) being all arranged on the same side with respect to the cutting path.
